(19) United States
(12) Patent Application Publication
(10) Pub. No.: US 2014/0321561 A1
(43) Pub. Date: Oct. 30, 2014

(54) SYSTEM AND METHOD FOR DEPTH BASED ADAPTIVE STREAMING OF VIDEO INFORMATION

(71) Applicant: DDD IP Ventures, Ltd., Road Town (VG)

(72) Inventors: Kevin John Stec, Los Angeles, CA (US); Peshala Vishvajith Pahalawatta, Glendale, CA (US)

(73) Assignee: DDD IP Ventures, Ltd., Road Town (VG)

(21) Appl. No.: 14/260,098

(22) Filed: Apr. 23, 2014

Related U.S. Application Data
(60) Provisional application No. 61/816,379, filed on Apr. 26, 2013.

(51) Int. Cl. H04N 19/46; H04N 19/80

(52) U.S. Cl. CPC H04N 19/00545; H04N 19/0089
USPC 375/240.29; 375/240.26

(57) ABSTRACT

Systems and methods for adaptive bitrate streaming of video information are provided. If a depth map can be derived or is independently available for the image sequence, the depth map can be used to selectively blur (effectively reducing the resolution of) background areas and to select encoding quantization parameters by image region in order to throttle the bitrate. In a cloud-based gaming application, the depth information can be used to selectively render background layers at lower resolutions thereby improving the compression efficiency of the rendered images.

### CROSS-REFERENCE TO RELATED APPLICATION

This application claims priority to U.S. Provisional Application No. 61/816,379, entitled “SYSTEM AND METHOD FOR DEPTH BASED ADAPTIVE STREAMING OF VIDEO INFORMATION,” and filed Apr. 26, 2013, the entirety of which is hereby incorporated by reference in its entirety.

### TECHNICAL FIELD

This disclosure is generally related to image and video processing. More specifically, this disclosure is related to adaptive bitrate streaming in a video encoding system.

### BACKGROUND

Adaptive streaming generally refers to a process that dynamically adjusts the bitrate of an image sequence (e.g., video content) delivered over a communication channel to ensure an optimal viewing experience based on changing channel capacity. Certain adaptive bitrate streaming processes may reduce the spatial and/or temporal resolution of the image sequence. Reducing the spatial and/or temporal resolution (e.g., sharpness) of foreground objects in the image sequence may provide reduced image quality. For example, when the image sequence is a three-dimensional (3D) image sequence, the 3D effect on a viewer's perception may be significantly reduced when the spatial resolution of foreground objects is low or when the frame rate is low. In addition, the 3D effect on a viewer's perception may be enhanced by keeping the foreground of the image sequence sharp while blurring the background of the image. Furthermore, maintaining foreground detail in a two-dimensional (2D) image sequence over a wide range of bitrates improves perceived image quality by maintaining sharpness in more salient regions (e.g., the foreground) of the image and providing smoother transitions between the different bitrates. Accordingly, there is a need for systems and methods for depth-based adaptive streaming of video information.

### SUMMARY

An apparatus for processing image or video information is provided. The apparatus comprises a memory unit configured to store image or video information comprising salience characteristics and depth information of the image or video information. The apparatus further comprises a processor operationally coupled to the memory and configured to identify at least two image regions having different salience characteristics based on at least one salience threshold and based on the depth information of the image or video information. The processor is further configured to process the image based on at least one constraint parameter associated with a communication channel and/or a target display of the image.

A method for processing image or video information is provided. The method comprises storing image or video information comprising salience characteristics and depth information of the image or video information. The method further comprises identifying at least two image regions having different salience characteristics based on at least one salience threshold and based on the depth information of the image or video information. The method further comprises processing the image based on at least one constraint parameter associated with a communication channel and/or a target display of the image.

An apparatus for processing image or video information is provided. The apparatus comprises means for identifying at least two image regions having different salience characteristics based on at least one salience threshold and based on the depth information of the image or video information. The apparatus further comprises means for processing the image based on at least one constraint parameter associated with a communication channel and/or a target display of the image.

### BRIEF DESCRIPTION OF THE DRAWINGS

The various features illustrated in the drawings may not be drawn to scale. Accordingly, the dimensions of the various features may be arbitrarily expanded or reduced for clarity. Furthermore, dotted or dashed lines and objects indicate optional features. In addition, some of the drawings may not depict all of the components of a given system, method or device. Finally, like reference numerals may be used to denote like features throughout the specification and figures.

FIG. 1 shows a high-level overview of a depth-based adaptive streaming system, in accordance with exemplary embodiments of the invention.

FIG. 2 is a functional block diagram of the depth-based adaptive streaming encoding system of FIG. 1, in accordance with exemplary embodiments of the invention.

FIG. 3 is a functional block diagram of additional depth-adaptive components of the adaptive preprocessor of FIG. 2, in accordance with exemplary embodiments of the invention.

FIG. 4 is a flowchart of an algorithm for depth-based adaptive filtering that may be performed by the adaptive preprocessor of FIG. 2, in accordance with exemplary embodiments of the invention.

FIG. 5 is a functional block diagram of additional depth-adaptive components of the controller of FIG. 2, in accordance with exemplary embodiments of the invention.

FIG. 6 is a flowchart of an algorithm for determining depth-based region of interest encoding parameters that may be performed by the controller of FIG. 2, in accordance with exemplary embodiments of the invention.

FIG. 7 is a functional block diagram of a scalable video encoder, in accordance with exemplary embodiments of the invention.

FIG. 8 is a functional block diagram of a receiver that may receive the scalable encoded bitstream generated by the scalable video encoder of FIG. 7, in accordance with exemplary embodiments of the invention.

FIG. 9 is a functional block diagram of the receiver of FIG. 8, in accordance with exemplary embodiments of the invention.

FIG. 10 is a flowchart of a method for depth-based adaptive streaming of source content, in accordance with exemplary embodiments of the invention.

### DETAILED DESCRIPTION

The detailed description set forth below in connection with the appended drawings is intended as a description of exemplary implementations of the disclosure and is not intended to represent the only implementations in which the disclosure may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the exemplary implementations of the disclosure. In some instances, some devices are shown in block diagram form.

While for purposes of simplicity of explanation, the methodologies may be shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

This disclosure provides systems and methods for adaptive bitrate streaming of video content. In some embodiments, methods for adaptive bitrate streaming may be configured to reduce the spatial and/or temporal resolution of an image sequence in order to code the image sequence at a lower bitrate. For example, the MPEG DASH standard specifies a framework for delivering content in which multiple versions of the image sequence are coded at multiple resolutions and the highest bitrate version that meets the current limitations of the channel capacity is streamed. Certain receivers/decoders of the image sequence may use adaptive scaling to smooth out any changes in resolution between sequences.

In some embodiments, depth information (e.g., a depth map) associated with the video content may be independently available or may be derived from an image sequence of the video content. As described in further detail below, the depth information may be used to selectively blur background areas of the image sequence. The depth information may also be used to select encoding quantization parameters (QP) by image region in order to throttle the bitrate of the encoded video content. Furthermore, in some embodiments providing cloud-based gaming, the depth information may be used to selectively render background layers at lower resolutions, thereby improving the compression efficiency of the rendered images.

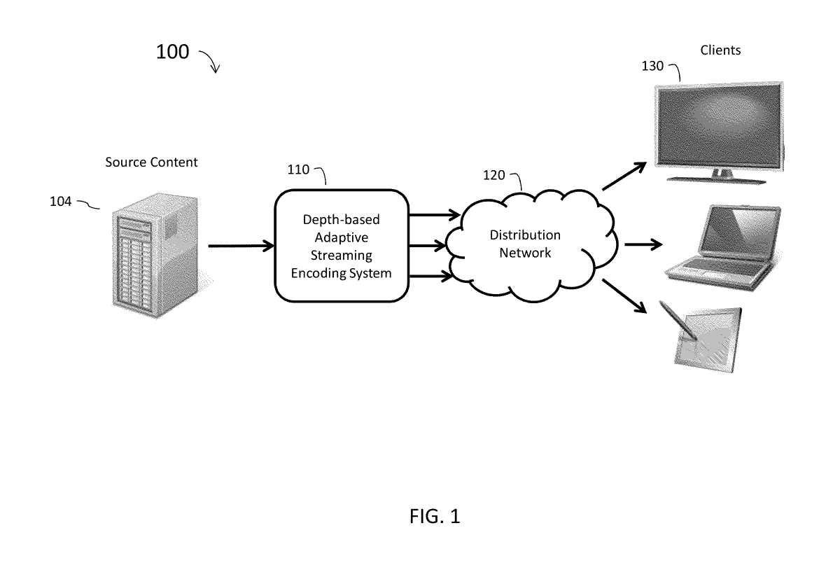

FIG. 1 shows a high-level overview of a depth-based adaptive streaming system 100, in accordance with exemplary embodiments of the invention. The depth-based adaptive streaming system 100 may comprise a depth-based adaptive streaming encoding system 110 (herein after “encoding system”) configured to adaptively stream source content 104 to clients 130 via a distribution network 120. The source content 104 may comprise media content, video content, or a sequence of color or grayscale images (e.g., video or image filed in material exchange format). The source content 104 may be received from a content creator or a content distributor. The encoding system 110 may be configured to receive and encode the source content 104 using a depth-based adaptive streaming process as described in further detail below.

The encoding system 110 may be configured to transmit the encoded content over a distribution network 120. The distribution network 120 may comprise various communication channels, such as cable service, satellite service, internet protocol (IP), and wireless networks, for distributing content to one or more clients 130. The clients 130 may comprise a multitude of display devices including smart televisions (TVs), personal computers (PC), tablets or phones. Each client 130 may be configured to request a different version of the encoded source content from the encoding system 110 based on the client's 130 capabilities and a communication channel capacity of the distribution network 120. As described below, the encoding system 110 may be configured to adaptively filter and encode the source content 104 to maintain foreground details, thereby providing encoded content having optimal visual quality for a given channel capacity and a target display (e.g., client 130). Visual quality generally refers to a perceived quality of experience of a typical user viewing the image or video. Visual quality may be measured subjectively using a rating system scored by the user or it may be approximated objectively using metrics such as peak signal to noise ratio (PSNR) and structural similarity metric (SSIM).

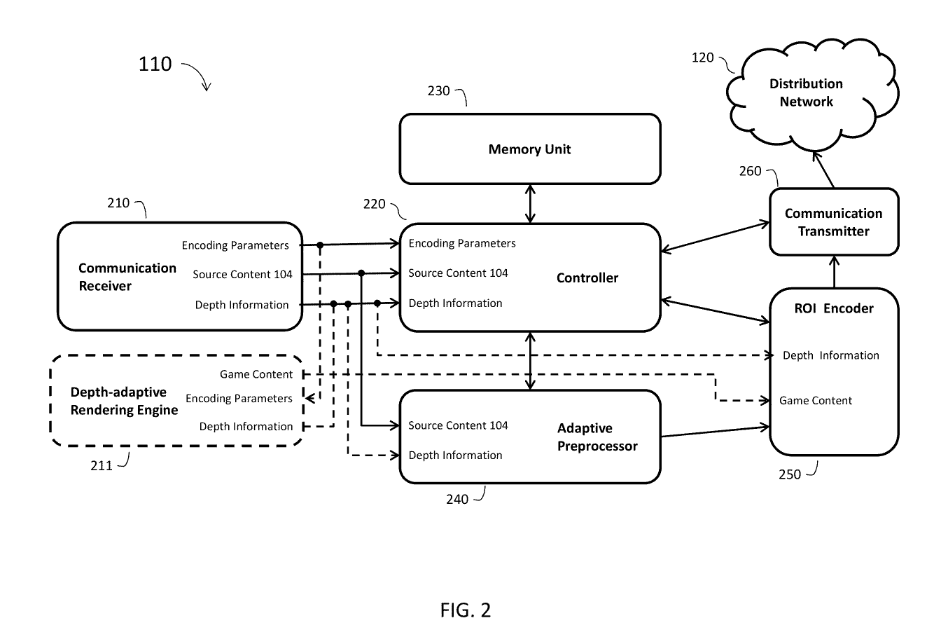

FIG. 2 is a functional block diagram of the depth-based adaptive streaming encoding system 110 of FIG. 1, in accordance with exemplary embodiments of the invention. The encoding system 110 may comprise a communication receiver 210 configured to receive source content 104, depth information associated with the source content 104, and encoding parameters for encoding the source content 104. As noted above, the source content 104 may comprise media content, video content, or a sequence of color or grayscale images.

The depth information received by the communication receiver 210 may have been derived using a variety of methods, for example, depth capture, computer-generated imagery (CGI) rendering, analysis of multi-view or stereo sources, or numerous synthesis methods commonly used for 2D to 3D conversion. The depth information may comprise a depth map, which may assign a depth value to each pixel of the images in the source content 104. In some embodiments, the depth information may be of a lower spatial and/or temporal resolution compared to the source content 104. In such embodiments, the encoding system 110 may be configured to perform spatial and/or temporal interpolation techniques to enhance the depth map to the same resolution as the source content 104.

The encoding parameters received by the communication receiver 210 may indicate constraint parameters for the encoded source content 104. For example, the encoding parameters may indicate at least one of a target average bit rate, a maximum instantaneous bit rate, a minimum instantaneous bit rate, and a length of a group of pictures (GOP) for the encoded source content 104. As described below, the encoding system 110 may be configured to constrain encoding of the source content 104 based on the encoding parameters. The encoding parameters may also indicate characteristics about a target display for the source content, such as a resolution of a display of the client 130 and a processing capability of the client 130. In exemplary embodiments, the client 130 may be configured to provide the encoding parameters and an indication of the client's characteristics to the communication receiver 210 of the encoding system 110, allowing for adaptive encoding of the source content 104 to the client 130.

As shown in FIG. 2, the encoding system 110 may also comprise a controller 220 coupled to the communication receiver 210. The controller 220 may comprise a micro-controller or a processor. The controller 220 may be configured or programmed with instructions to receive information from each of the components of the encoding system 110, perform calculations based on the received information, and generate control signals for each of the components of the encoding system 110 based on the performed calculations in order to adjust an operation of each component. In exemplary embodiments, the controller 220 may be configured to receive the source content 104, the depth information, and the encoding parameters as inputs from the communication receiver 210. In some embodiments, the controller 220 may be configured to determine the depth information from the source content 104 based on a synthesis method (e.g., a 2D to 3D conversion synthesis method). As described below, the controller 220 may be configured to dynamically adapt both preprocessing and encoding decisions based on the source content 104, the depth information, and the encoding parameters.

With respect to adaptive preprocessing decisions, the controller 220 may be configured to analyze the depth information and compute a depth value at a given pixel location to determine horizontal, vertical, and temporal filtering parameters to be used for filtering the associated location of the video source. Such filtering may include separable or non-separable spatial filtering. The controller 220 may also determine the filtering parameters based on the encoding parameters, such as a target bit rate.

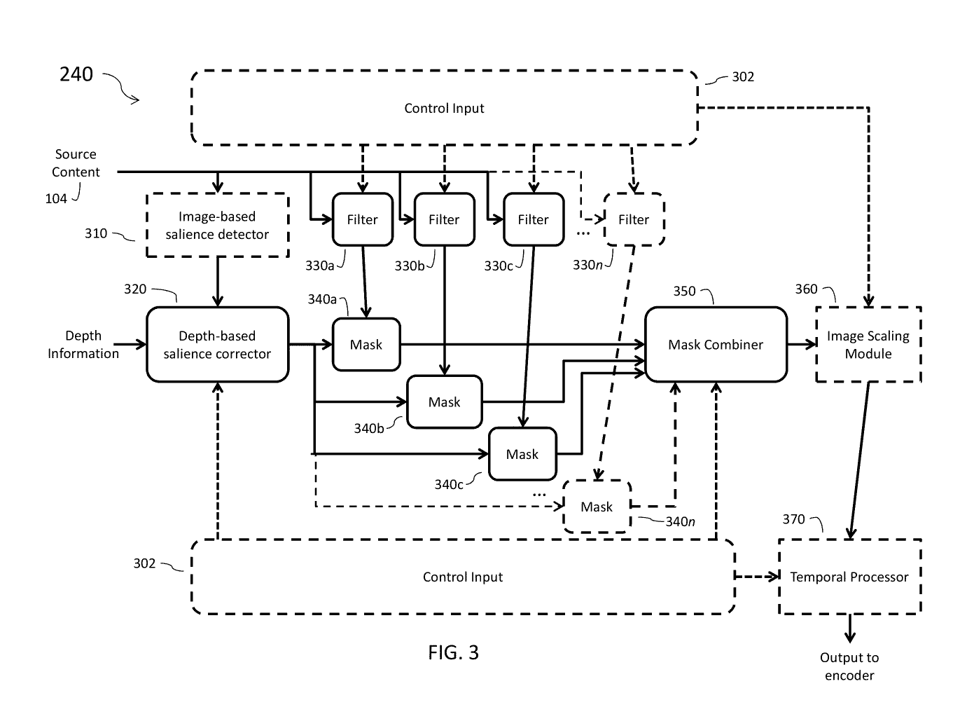

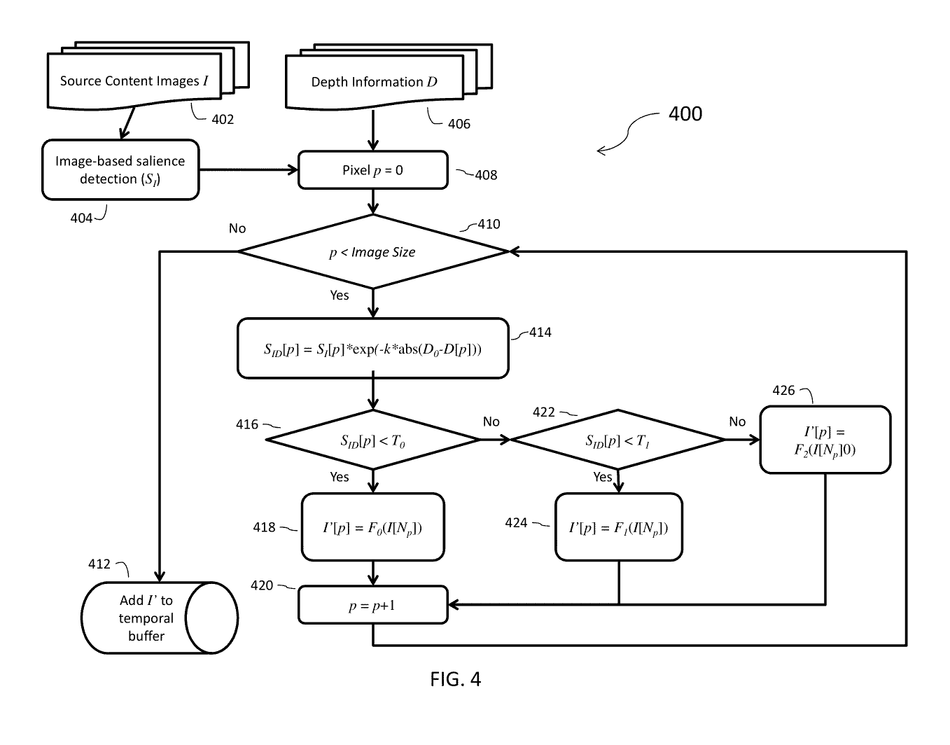

In image and video processing, saliency generally refers to the importance or distinctiveness of an object in the source content 104 compared to other neighboring objects. Salience characteristics may include edge information, local contrast, face/flesh-tone detection, and motion information in addition to the depth. In exemplary embodiments, the filtering parameters may also be based on an analysis of the source content 104 salience characteristics as further described below with reference to FIG. 3 and FIG. 4.

In exemplary embodiments, the controller may be configured to identify at least two image regions of the source content 104 having different salience characteristics based on at least one salience threshold, and based on the depth information of an image of the source content 104. The controller 220 may be further configured to process the image based on at least one constraint parameter (e.g., the target bit rate) associated with a communication channel (e.g., distribution network 120) and/or a target display (e.g., client 130) of the image. The controller 220 may be also configured to scale a resolution of the source content 104, either before or after preprocessing, in order to maximize the perceived visual quality subject to the constraint parameter.

In one embodiment, the controller 220 may be configured to encode both the source content 104 and depth information and the controller 220 may be further configured to control preprocessing parameters for the depth information. The preprocessing parameters for the depth information may include dynamic range compression parameters and additional scaling parameters for the output depth resolution, in addition to the spatial and temporal filtering parameters used for source content 104 preprocessing. In this embodiment, the controller 220 may also be configured to determine the preprocessing parameters for the depth information based on a target bit rate as well as image salience characteristics as described herein.

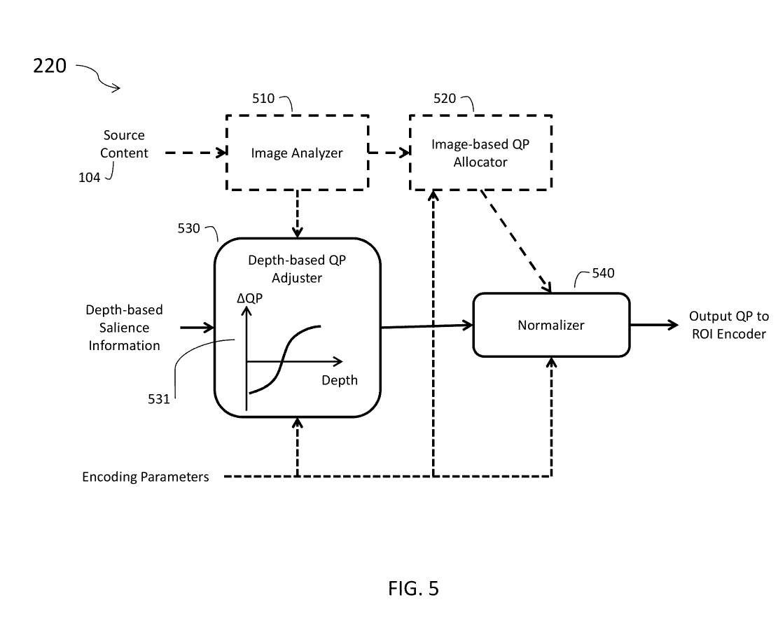

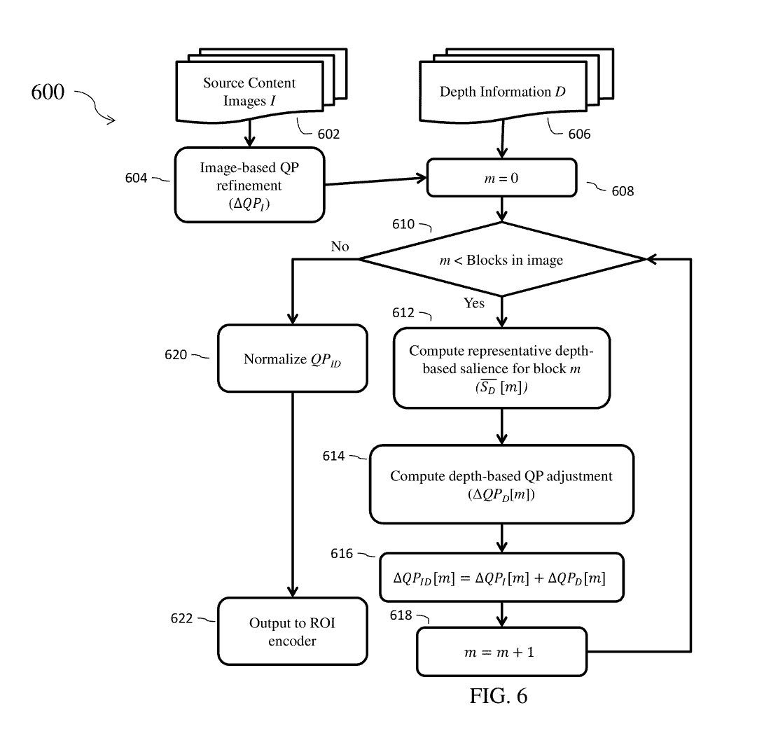

As noted above, the controller 220 may be configured to dynamically adapt encoding decisions based on the source content 104, the depth information, and the encoding parameters. With respect to adaptive encoding decisions, the controller 220 may be configured to analyze the depth information and adjust the encoding parameters based on the depth information. For example, the controller 220 may be configured to determine quantization parameters for a region of an image based on a depth value associated with the region as further described below with reference to FIG. 5 and FIG. 6.

The encoding system 110 may also comprise a memory unit 230 coupled to the controller 220. The memory unit 230 may comprise random-access memory (RAM), electrically erasable programmable read only memory (EEPROM), flash memory, or non-volatile RAM. The memory unit 230 may be configured to temporarily or permanently store data for use in read and write operations performed by the controller 220. In exemplary embodiments, the memory unit may be configured to store image or video (e.g., source content 104) information comprising salience characteristics and depth information about the image or video information. The memory unit 230 may be further configured to store the encoding parameters, the spatial filtering parameters, the temporal filtering parameters, and information related to other calculations performed by the controller 220.

The encoding system 110 may also comprise an adaptive preprocessor 240 coupled to the controller 220 and the communication receiver 210. The adaptive preprocessor 240 may be configured to receive the source content 104 from the communication receiver 210 and the preprocessing control signals generated by the controller 220. In some embodiments, the adaptive preprocessor 240 may also be configured to receive the depth information.

In exemplary embodiments, the adaptive preprocessor 240 may be to perform image processing operations on images of the source content 104 based on the preprocessing control signals provided by the controller 220. In these embodiments, the controller 220 may generate filtering parameters as described herein and provide the filtering parameters to the adaptive preprocessor 240. The adaptive preprocessor 240 may be configured to apply filters (e.g., low-pass filters) on the source content 104 based on the filtering parameters received from the controller 220 as further described below with respect to FIG. 3 and FIG. 4. In some embodiments, the adaptive preprocessor 240 may be further configured to perform scaling of the preprocessed image depending on the preprocessing control signals received from the controller 220. As such, the adaptive preprocessor 240 may be configured to provide the preprocessed content as output. As further described herein, filtering of the source content 104, as described above, may reduce the amount of bits required to encode the images of the source content 104, thereby providing higher image quality at a given bit rate.

In embodiments where the adaptive preprocessor 240 is configured to receive the depth information, the adaptive preprocessor 240 may be further configured to preprocess the depth information by the processes described in FIG. 3 and FIG. 4. Furthermore, in addition to depth-based processing, the adaptive preprocessor 240 may be configured to include other image processing operations, such as color and contrast enhancements and de-blocking.

The encoding system 110 may also comprise a region of interest (ROI) encoder 250 coupled to the controller 220 and the adaptive preprocessor 240. In the field of image and video processing, region of interest coding generally refers to a process of selectively coding certain blocks in an image frame at a higher quality than other areas considered of less visual importance (e.g., less salient). For further information about ROI coding, reference is made to Zhang et al. “Depth based region of interest extraction for multi-view video coding” Int. Conf. on Machine Learning and Cybernetics (2009), which is hereby incorporated by reference in its entirety. As described therein, ROI coding may be implemented as part of the rate control process of a video encoder. However, in certain implementations, ROI coding may be limited due to a lack of reliable information to properly identify specific regions of interest and the results may be limited by the coarseness of the blocks. The depth-based adaptive streaming encoding system 110 may be configured to identify specific regions of interest based on the depth information to avert such limitations, as further described below.

The ROI encoder 250 may be configured to receive the preprocessed (e.g., filtered) content from the adaptive preprocessor 240 and the encoding control signals from the controller 250 as input. The ROI encoder 250 may be configured to encode the preprocessed content according to the encoding control signals. In some embodiments, the encoding control signals may comprise depth-based encoding parameters adaptively generated by the controller 220 as described in further detail below with reference to FIG. 5 and FIG. 6. In some embodiments, the encoding control signals may indicate quantization parameter (QP) adjustment information that may be used to determine a bit allocation for different regions of the encoded image. In some embodiments, the encoding control signals may include encoding parameters indicating macroblock coding modes to use, or avoid, for particular regions of the encoded image. For example, the encoding control signals may identify less bit rate intensive coding modes to use, such as SKIP modes, for less salient regions of the image and may identify that intra coding of macroblocks should be avoided. As such, the ROI encoder 250 may be configured to encode the preprocessed content based on the received encoding parameters. The ROI encoder 250 may be configured according to a video encoding standard (e.g., AVC/H.264, HEVC/H.265, VP9, etc.). The ROI encoder 250 may also be configured to encode the preprocessed source content 104 in blocks (e.g., macroblocks or coding units) that comprise multiple pixels where each block may be allocated a QP value as further described below with reference to FIG. 6.

In some embodiments, the ROI encoder 250 may also be configured to provide feedback to the controller 220 indicating the encoded bit rate and encoded quality of the encoded content. In this embodiment, the controller 220 may be further configured to adjust both the preprocessing parameters and the ROI encoding parameters for subsequent encoding passes, or a subsequent input image. The controller 220 may also be configured to perform multi-pass encoding such that the decision of the controller 220 are informed by the previous encoding passes using the feedback information from the ROI encoder 250.

The encoding system 110 may also comprise a communication transmitter 260 coupled to the controller 220 and the ROI encoder 250. The communication transmitter 260 may be configured to receive the encoded content from the ROI encoder 250. Accordingly, the communication transmitter 260 may be configured to provide the encoded content to the distribution network 120 for delivery to clients 130.

In other embodiments, the encoding system 110 may be further configured as a cloud-based game encoding and transmission system. Cloud-based gaming systems generally refer to gaming systems that render game content in a remote (e.g., “cloud”) server and stream the game content to a gaming client. Unlike an on-demand video streaming scheme in which the source content 104 is input to the system, a cloud-based gaming scheme generates its own source video content in real-time. As described herein, depth-adaptive processing may significantly improve the perceived quality and resolution of the rendered images by rendering more important regions at a better quality and resolution.

In cloud-based gaming embodiments, the encoding system 110 may further comprise a depth-adaptive rendering engine 211 (herein after “rendering engine”) coupled to the controller 220, the adaptive preprocessor 240, and the ROI encoder 250. In this embodiment, the rendering engine 211 may be configured to generate game content and depth information. The rendering engine 211 may comprise a Z-buffer (not shown) configured to render the game content, where conceptually, Z denotes the depth axis. The Z-buffer may be configured to render objects in the game content one-by-one in any order. For each pixel of the game content, the Z-buffer may be configured to store a depth value and a corresponding color value. The Z-buffer may be further configured to determine the depth value that is the closest seen so far, thereby ensuring that nearer objects will occlude further objects in the rendered image. The Z-buffer may also be configured to provide information about the depth of each object to the ROI encoder 250 in order to enable depth-based ROI selection. The rendering engine 211 may also be configured to adjust a level of rendering detail based on the depth information generated by the Z-buffer, such that background layers of the game content may be rendered at a lower level of detail to reduce processing overhead.

In cloud-based gaming embodiments, the encoding parameters input to the controller 220 may comprise information indicating a target bit rate, an amount of time available for rendering, a number of processors that are available for encoding, a minimum and maximum depth of objects in the scene, as well as depth-based rendering parameters. The controller 220 may be configured to assign a rendering complexity for each depth layer and image region based on the input depth information from the rendering engine 211 and the client's 130 capabilities. Accordingly, the rendering engine 211 may be configured to perform rendering of each image region of the source content 104 based on the depth of the rendered image and input from the controller 220. The rendering engine 211 may also be configured to provide the rendered content to the ROI encoder 250, which may be configured as described herein.

Moreover, the above embodiments of the encoding system 110 may be configured for preprocessing and encoding using any number of encoding formats, such as 2D, stereoscopic 3D, 2D with depth, multi-view, or multi-view with depth. The encoding system 110 may be further configured to use depth information to render additional views or display adaptations in order to provide a more comfortable viewing experience.

FIG. 3 is a functional block diagram of additional depth-adaptive components of the adaptive preprocessor 240 of FIG. 2, in accordance with exemplary embodiments of the invention. As described above, the adaptive preprocessor 240 may be configured to receive the source content 104 and the depth information as inputs from the communication receiver 210. To perform its functions, the adaptive preprocessor 240 may also be configured to receive control inputs 302 from the controller 220. As described above, the adaptive preprocessor 240 may be configured to perform filtering (e.g., low-pass filtering) of the source content 104 based on saliency information. As such, the adaptive preprocessor 240 may generate and provide preprocessed content having improved visual quality at a given bit rate.

As shown in FIG. 3, the adaptive preprocessor 240 may comprise an image-based salience detector 310 (herein after “salience detector”) configured to receive the source content 104 from the communication receiver 210. As described above, saliency generally refers to the importance or distinctiveness of an object in the source content 104 compared to other neighboring objects. The salience detector 310 may be configured to perform salience detection based on various techniques to generate saliency information. The saliency information may indicate image-based saliency values for pixel of the source content 104. For further information on salience detection, reference is made to both M-M. Cheng et al., “Global Contrast Based Salient Region Detection,” Proceedings of CVPR (2011) and F. Perazzi, et. al., “Saliency Filters: Contrast Based Filtering For Salient Range Detection” Proceedings of CVPR (2012), which are both hereby incorporated by reference in their entirety.

The adaptive preprocessor 240 may also comprise a plurality image filters 330 (e.g., filter 330a, filter 330b, filter 330c . . . filter 330n) configured to receive the source content 104. The adaptive preprocessor 240 may also be configured to receive control input 302 from the controller 220. As shown in FIG. 3, the adaptive preprocessor 240 may comprise n filters 330, where n is an integer. In an exemplary embodiment, the adaptive preprocessor 240 may comprise three filters (e.g., filter 330a, filter 330b, and filter 330c). Each filter 330 may be configured to filter (e.g., low-pass filter) the source content 104. The filters 330 may comprise horizontal filters, vertical filters, or both and may also comprise separable or non-separable filters. The filters 330 may also be configured to filter the source content 104 based on filter parameters indicated by the control input 302 received from the controller 220. The filter parameters may be based on the target bit rate requirements, the image resolution, and other image characteristics and encoding parameters as described above. In some embodiments, each filter 330 may use filtering parameters that are different from the filtering parameters used by the other filters 330.

The adaptive preprocessor 240 may also comprise a depth-based salience corrector 320 (herein after “salience corrector”) coupled to the salience detector 310. The salience corrector 320 may be configured to receive the depth information from the communication receiver 210 and the salience information from the salience detector 310. The salience corrector 320 may be configured to combine the salience information with the depth information to obtain depth-based salience information as described below. For example, the depth-based salience S_{ID} of a pixel at location x, S_{ID}(x), may be computed according to Equation (1):

S_{ID}(x)=S_{I}(x)*exp(−k*abs(D₀−d(x))) (1)

Where the image-based salience, as determined by the salience detector 310, is denoted by S_{I}(x) for a particular pixel location x in the source image of source content 104. In Equation (1), x is a vector that represents the row and column coordinates of the pixel location in the image. In Equation (1), k is a constant that determines the depth-based correction strength. In Equation (1), D₀ is an image dependent constant that represents the most salient depth layer in the image, and d(x) is the depth at that pixel location. For example, setting D₀=0, sets the nearest depth layer to the viewer as the most salient depth. In Equation (1), the depth-based salience value S_{ID} at a pixel location x decreases as the depth of the object at that location d(x) diverges from the depth of the most salient depth layer D₀ and increases as the object moves closer to the depth of the most salient depth layer D₀.

Accordingly, the salience corrector 320 may use Equation (1) above determine a depth-based saliency value S_{ID} for each pixel p of the source content 104. Furthermore, the salience corrector 320 may be configured to determine a plurality of salience thresholds that indicate which regions of the source content 104 are more salient than other regions. In other embodiments, alternate mappings from S_{I}(x) and d(x) to S_{ID}(x) may also be used.

The adaptive preprocessor 240 may also comprise a plurality of masks 340 (e.g., mask 340a, mask 340b, mask 340c . . . mask 340n). As shown in FIG. 3, the adaptive preprocessor 240 may comprise n different masks 340, where n is an integer. In an exemplary embodiment, the adaptive preprocessor 240 may comprise three masks (e.g., mask 340a, mask 340b, and mask 340c). Each mask 340 may be coupled to the salience corrector 320 and to one of the filters 330. In an exemplary embodiment, the salience corrector 320 may be configured to determine two salience thresholds and, consequently, the adaptive preprocessor 240 may comprise three mutually exclusive masks (e.g., Mask 340a, Mask 340b, and Mask 340c). In other embodiments the adaptive preprocessor 240 may be comprise a different number of masks 340 depending on the number of salience thresholds determined by the salience corrector 320.

Each mask 340 may be configured to receive the filtered source content 104 from the filter 330 coupled thereto. For example, as shown in FIG. 3, the first mask 340a may be configured to receive the filtered source content 104 from the first filter 330a, the second mask 340b may be configured to receive the filtered source content 104 from the second filter 330b, and the third mark 340c may be configured to receive the filtered source content 104 from the first filter 330c. Furthermore, each mask 340 may be configured to receive the saliency information from the salience corrector 320. Each mask 340 may be configured to partition the received filtered source content 104 to generate a mutually exclusive depth-based salience layer based on the salience thresholds determined by the salience corrector 320. In some embodiments, the masks 240 may be configured to mask the filtered source content 104 to generate masked images by zeroing out pixels that don't belong to the associated layer and passing through pixels that are within the associated layer.

The adaptive preprocessor 240 may also comprise a mask combiner 350 (herein after “combiner”) coupled to each of the masks 340 and may be configured to receive the masked images from each of the masks 340. The combiner 350 may be configured to combine the masked images to form one complete image. In one embodiment, the combiner 350 may be configured to add the received masked images to obtain the final image. In another embodiment, the combiner 350 may be further configured to perform additional processing to blend the boundaries of the masked images in the final image in order to reduce boundary artifacts. In some embodiments, the masked images may be overlapping, and the combiner 350 may be configured to perform a weighted combination of the masked images in order to determine the final pixel value for each image location in the combined image.

The adaptive preprocessor 240 may also comprise an image scaling module 360 coupled to the combiner 350. The image scaling module 360 may be configured to receive the combined final image from the combiner 350 and control inputs 302 from the controller 220. The image scaling module 360 may be configured to scale the final image received from the combiner 350 based on a target bit rate indicated by the control input 302. As such, the image scaling module 360 may be configured to generate a scaled image having a different resolution than the final image received from the combiner 350. As such, the image scaling module 360 may improve perceived video information based on the communication channel (e.g., distribution network 120) and/or target display of the image (e.g., display of client 130).

The adaptive preprocessor 240 may also comprise a temporal processor 370 coupled to the image scaling module 360. The temporal processor 370 may be configured to receive the scaled image from the image scaling module 360 and control inputs 302 from the controller 220. The temporal processor 370 may be configured to perform motion adaptive or motion compensated temporal filtering on the scaled image in order to reduce temporal fluctuations in the filtered image, thereby increasing compression efficiency when encoded. The temporal processor 370 may be further configured to determine a filter strength for temporal filtering of each salience layer based on the depth-based salience information. The temporal processing module 370 may be configured to provide the temporally filtered images to the ROI encoder 250.

As described above with reference to FIG. 3, the adaptive preprocessor 240 may be configured to filter the source content 104 based on depth-based saliency values of the source content 104 and at least one salience threshold. In order to perform its functions, the adaptive preprocessor 240 may operate according to a depth-based adaptive filtering algorithm.

FIG. 4 is a flowchart of an algorithm 400 for depth-based adaptive filtering (herein after “filtering algorithm”) that may be performed by the adaptive preprocessor 240 of FIG. 2, in accordance with exemplary embodiments of the invention. The operations executed by the adaptive preprocessor 240 in the algorithm perform filtering of the source content 104 using three filters 330 and combining the filtered images using three salience-based image masks 340 as described above with reference to FIG. 3.

At block 402, the adaptive preprocessor 240 may receive source content images I (e.g., source content 104). At block 404, the adaptive preprocessor 240 may perform image-based salience detection on the source images in order to compute image-based salience values S_{I}. At block 406, the adaptive preprocessor 240 may receive depth information D. In some embodiments, the source content images I and the depth information D may have the same spatial and temporal resolution.

As described above with reference to FIG. 3, the adaptive preprocessor 240 may be configured to determine depth-based salience values S_{ID} for each pixel of the source content images I as a function of the image-based salience values S_{I} and the most salient depth D₀. At block 408, the adaptive preprocessor 240 may begin processing the pixels p of the source content images I, where represents an index to a location of a pixel in the image I, for example, in scan order. At block 408, the adaptive preprocessor 240 may set the pixel p equal to 0.

The adaptive preprocessor 240 may enter decision block 410 which determines whether the processing of the entire source content image I is complete. The adaptive preprocessor 240 may determine whether the current pixel p is less than the image size (e.g., resolution) of the source content image I, thereby determining whether all of the pixels of the source content image I have been processed. The adaptive preprocessor 240 may determine that the current pixel p is not less than the image size (e.g., p is greater than or equal to the image size) and the adaptive preprocessor 240 may exit the decision block 410 and continue to block 412. At block 412, the adaptive preprocessor 240 may provide the processed image I′ to the temporal buffer for further temporal filtering and encoding. The adaptive preprocessor 240 may alternatively determine that the current pixel p is less than the image size and the adaptive preprocessor 240 may continue to process and filter the image at block 414 as described below.

At block 414 the adaptive preprocessor 240 may determine the depth-based salience value S_{ID}[p] for the current pixel p of the source content image I according to Equation (1) as described above with reference to FIG. 3. Based on Equation (1), the depth-based salience value for the current pixel p may be computed according to Equation (2):

S_{ID}[p]=S_{I}[p]*exp(−k*abs(D₀−D[p])) (2)

In this embodiment, the adaptive preprocessor 240 may determine two salience thresholds (e.g., T₀ and T₁) in order to partition the source content image I into three corresponding regions based on the salience (e.g., importance) of each region, corresponding to the masks 340 of FIG. 3. The adaptive preprocessor 240 may adjust color values of each pixel in each region using a filter (e.g., one of F₀, F₁, F₂), which may operate on a neighborhood Nₚ of the current pixel p.

At block 416, the adaptive preprocessor 240 may determine whether the depth-based salience of the current pixel S_{ID}[p] is less than the first salience threshold T₀. If the depth-based salience of the current pixel p is less than the first salience threshold T₀, the adaptive preprocessor 240 may continue to block 418. At block 418 the adaptive preprocessor 240 may apply the first filter F₀ to the neighborhood Nₚ of the current pixel p and may store the filtered pixel values in the processed image I′[p] at the pixel location of the current pixel. The adaptive preprocessor 240 may continue to block 420 where the current pixel p may be incremented to the next pixel in the source content image I. After incrementing, the adaptive preprocessor 240 may return to the start of the decision block 410.

At block 416, the adaptive preprocessor 240 may determine that the depth-based salience of the current pixel S_{ID}[p] is not less than the first salience threshold T₀ and the adaptive preprocessor 240 may continue to block 422. At block 422, the adaptive preprocessor 240 may determine whether the depth-based salience of the current pixel S_{ID}[p] is less than the second salience threshold T₁. The adaptive preprocessor 240 may determine that the depth-based salience of the current pixel S_{ID}[p] is less than the second salience threshold T₁ and the adaptive preprocessor 240 may continue to block 424. At block 424, the adaptive preprocessor 240 may apply the second filter F₁ to the neighborhood Nₚ of the current pixel p and may store the filtered pixel values in the processed image I′[p] at the pixel location of the current pixel. The adaptive preprocessor 240 may continue to block 420 where the current pixel p may be incremented to the next pixel in the source image I and the adaptive preprocessor 240 may return to the start of the decision block 410.

At block 422, the adaptive preprocessor 240 may determine that the depth-based salience of the current pixel S_{ID}[p] is not less than the second salience threshold T₁ and the adaptive preprocessor 240 may continue to block 426. At block 426, the adaptive preprocessor 240 may apply the third filter F₂ to the neighborhood Nₚ of the current pixel p and may store the filtered pixel values in the processed image I′[p] at the pixel location of the current pixel. The adaptive preprocessor 240 may continue to block 420 where the current pixel p may be incremented to the next pixel in the source image I and the adaptive preprocessor 240 may return to the decision block 410.

As described above, the adaptive preprocessor 240 may exit the decision block 410 if the adaptive preprocessor 240 determines that the current pixel p is not less than the image size.

FIG. 5 is a functional block diagram of additional depth-adaptive components of the controller 220 of FIG. 2, in accordance with exemplary embodiments of the invention. As described above with reference to FIG. 2, the controller 220 may be configured to analyze the depth information and adjust the received encoding parameters based on the depth information. The controller 220 may also be configured to provide quantization parameters (QP) to the ROI encoder 250 to dynamically adapt encoding decisions of the ROI encoder 250.

In image and video encoding, quantization generally refers to a process that reduces a number of discrete levels used to represent coefficients of a frequency transform performed on a localized region (e.g., macroblock or sub-macroblock) of the image. The reduction in the amount of discrete levels is determined by the QP. A smaller QP provides finer levels of quantization and a larger QP provides coarser levels of quantization. Consequently, allocating smaller QP values may result in a higher bit allocation and better quality encoded video compared to allocating larger QP values.

As described above with reference to FIG. 2, the controller 220 may be configured to receive source content 104 and encoding parameters from the communication receiver 210 and depth-based salience information from the adaptive preprocessor 240. As shown in FIG. 5, the controller 220 may comprise an image analyzer 510 configured to receive the source content 104. The image analyzer 510 may be configured to determine first and second order statistics (e.g., mean or variance) of image blocks or regions of the source content 104. In some embodiments, the image statistics may indicate a temporal and spatial complexity of the image. The image analyzer 510 may also be configured to determine a potential for errors in residual coding to propagate from the image to subsequently coded images (e.g., a likelihood of the image being used as a reference in subsequent images).

The controller 220 may also comprise an image-based QP allocator 520 coupled to the image analyzer 510. The image-based QP allocator 520 may be configured to receive the image statistics and the potential for error propagation determined by the image analyzer 510. The QP allocator 520 may also be configured to determine QP values based on the encoding parameters and adjust the QP values assigned to individual blocks within an image of the source content 104 in order to more efficiently allocate target bits within the images of the source content 104.

The image-based QP allocator 520 may be configured to determine an average QP value for a given image of the source content 104 based on the image statistics and the potential for error propagation in order to achieve a rate control scheme indicated by the encoding parameters. For example, the controller 220 may be configured to increase the QP value as the image statistics increase (e.g., increased complexity) and decrease the QP value as the image statistics decrease (e.g., decreased complexity) in order to achieve the target bit rate and improve visual quality. In another example, the controller 220 may be configured to decrease the QP value as the potential for error propagation increases and increase the QP value as the potential for error propagation decreases.

The controller 220 may also comprise a depth-based QP adjuster 530 coupled to the image analyzer 510. The depth-based QP adjuster 530 may be configured to receive the depth-based salience information and the image statistics determined by the image analyzer 510. The depth-based QP adjuster 530 may be configured to adjust the QP at an image block level based on the depth-based salience information and the image statistics, thereby providing ROI bit allocation as described above. The depth-based QP adjuster 530 may determine depth-based QP adjustments ΔQP_{D} using a sigmoidal curve 531 where depth layers that are further away from the salient depth level result in a higher, typically positive, QP adjustments ΔQP_{D}, and depth layers that are close to the salient depth level result in a lower, typically negative, QP adjustments ΔQP_{D}.

The controller 220 may also comprise a normalizer 540 coupled to the depth-based QP adjuster 530 and the image-based QP allocator 520. The normalizer 540 may be configured to receive the depth-based QP adjustments from the depth-based QP adjuster 530, the image-based QP adjustments from the image-based QP allocator 520, and the encoding parameters. The normalizer 540 may be configured to add the depth-based QP adjustments and the image-based QP adjustments to determine overall QP adjustment values. The normalizer 540 may be further configured to modify the overall QP adjustment values based on the encoding parameters (e.g., target bit rate, QP adjustment threshold, and average QP). The normalizer 540 may be configured to linearly scale the overall QP adjustment values based on the encoding parameters in order to achieve, for example, a target average QP or bit rate for the processed image. The normalizer 540 may also be configured to provide the modified QP values to the ROI encoder 250. As such, the controller 220 may be configured to achieve an overall target bit rate for the encoded content while maintaining visual quality by modifying the QP parameters based on the depth-based salience information. As described above, the overall target bit rate may depend on the characteristics of the communication channel (e.g., distribution network 120) used to transmit the encoded content.

FIG. 6 is a flowchart of an algorithm 600 for determining depth-based region of interest (ROI) encoding parameters that may be performed by the controller 220 of FIG. 2, in accordance with exemplary embodiments of the invention. As described above, the ROI encoder 250 may be configured to code the source content 104 in blocks (e.g., macroblocks or coding units) where each block comprises multiple pixels and may be encoded based on an associated QP value. Accordingly, the controller 220 may be configured to determine QP values for encoding each block of the source content 104 based on the depth information as described below.

At block 602, the controller 220 may receive source content images I (e.g., source content 104). At block 604, the controller 220 may calculate image-based QP adjustment values ΔQP_{I} by analyzing characteristics of the source content images I as described above with reference to FIG. 5. At block 606, the controller 220 may receive depth information D. At block 608, the controller 220 may begin processing with the first block m of the source content image I by setting the current block m equal to 0.

The controller 220 may enter decision block 610, where the controller 220 may determine whether the processing for each block m of the source content image I is complete. At block 610, the controller 220 may determine that the current block m is less than the number of blocks in the source content image I, indicating that processing of the source content image I is not complete, and may continue to block 612. The controller 220 may alternatively determine that the current block m is not less than the number of blocks in the source content image I (e.g., m is greater than or equal to the number of blocks in the image) and the controller 220 may exit the decision block 610 and continue to block 620.

The controller 220 may be further configured to compute a representative depth-based salience value S̅_̅{̅D̅}̅[m] for each block m (comprising multiple pixels p) of the source content image I based on the source content images I depth information D. The representative depth-based salience value S̅_̅{̅D̅}̅[m] may be based on first or second order statistics. For example, in one embodiment, the controller 220 may be configured to compute the depth-based salience value representative of the block S̅_̅{̅D̅}̅[m] by computing the mean depth-based salience value S̅_̅{̅D̅}̅ over all of the pixels p in the block m. In other embodiments, the controller 220 may determine the depth-based salience values representative of the block m by computing the maximum, median, or variance of the depth-based salience values for the pixels p of the block m. As shown in Equation (1) and Equation (2) above, the depth-based salience value S_{D} for a pixel p may be computed according to Equation (3):

S_{D}[p]=exp(−k*abs(D₀−D[p])) (3)

At block 614, the controller 220 may compute a depth-based QP adjustment value (ΔQP_{D}[m]) for the block m based on the mean depth-based salience value S̅_̅{̅D̅}̅[m]. As described above with reference to FIG. 5, in an exemplary embodiment, the controller 220 may determine depth-based QP adjustment values based on the sigmoidal function 531. In an exemplary embodiment, the sigmoidal function 531 may be computed according to Equation (4):

ΔQP_{D}[m]=C((0.5− S̅_̅{̅D̅}̅[m])/(1+ S̅_̅{̅D̅}̅[m])) (4)

In Equation (4), C is a constant that controls the dynamic range of the QP adjustment.

At block 616, the controller 220 may combine the depth-based QP adjustment value ΔQP_{D}[m] with the image-based QP adjustment value ΔQP_{I}[m] to determine an image and depth-based QP adjustment value ΔQP_{ID}[m]. In one embodiment, the controller 220 may combine the depth-based and image-based QP adjustment values by adding them together. In other embodiments, the controller 220 may combine the depth-based and image-based QP adjustment values using other functions, such as multiplication or weighted sum, in order to fine-tune the QP adjustment.

At block 618, the controller 220 may increment to the next block m in the source content image I. After incrementing, the controller 220 may return to decision block 610.

As described above, at block 610 the controller 220 may determine that the current block m is not less than the number of blocks in the source content image I and the controller 220 may exit the decision block 610 and continue to block 620. At block 620, the controller 220 may normalize the image and depth-based QP adjustment value ΔQP_{ID}[m] in order to achieve a target average QP adjustment value. The controller 220 may derive the target average QP adjustment based on the target bit rate indicated by the encoding parameters and characteristics (e.g., temporal and spatial complexity) of the source content 104. At block 622, the controller 220 may provide the normalized QP value to the ROI encoder 250, thereby adjusting the encoded bitrate of the corresponding block in the source content 104.

In some embodiments, the depth-based preprocessing and ROI encoding scheme described above may be used in an adaptive streaming environment, such as in Over-The-Top (OTT) delivery of image or video content to portable devices or smart TVs. The depth-based preprocessing and ROI encoding scheme may provide improved visual quality as described below. In OTT delivery, bandwidth may be limited and quality of service may vary depending on location. As such, delivery schemes that result in graceful degradation of image quality may improve the quality of experience to the viewer. The depth-based preprocessing and ROI encoding schemes described above may be used to provide graceful degradation of image resolution by limiting reduction in resolution to depth layers that are less important (e.g., less salient) to the viewer. The depth-based preprocessing and ROI encoding schemes described above may also apply to dynamic adaptive streaming systems such as MPEG DASH, as well as real-time encoding and transmission applications such as video conferencing, providing improved visual quality.

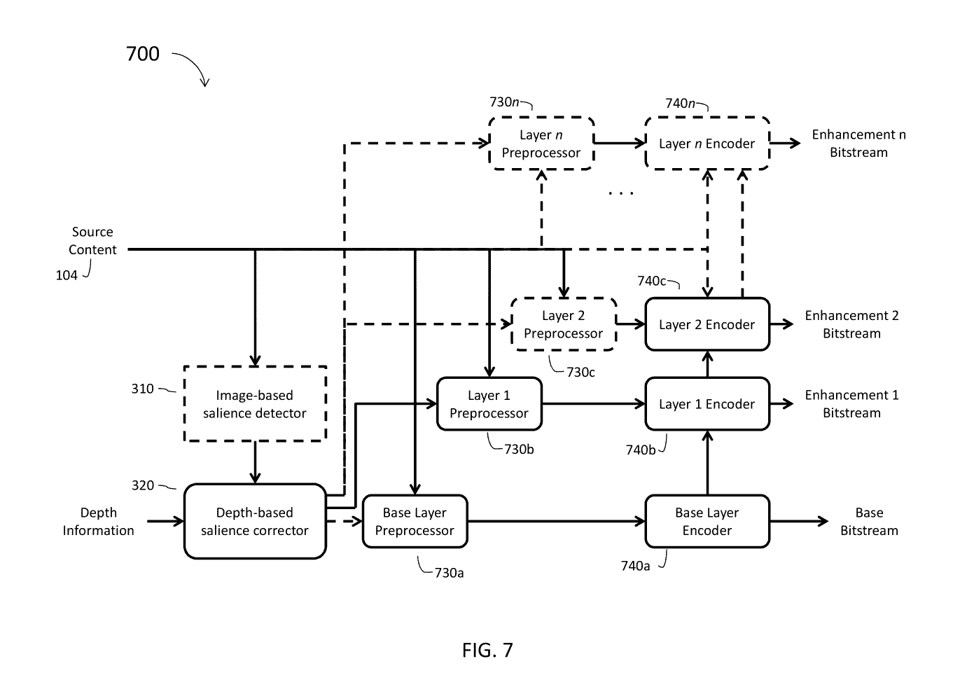

FIG. 7 is a functional block diagram of a scalable video encoder 700 (herein after “scalable encoder”), in accordance with exemplary embodiments of the invention. As described below, the scalable encoder 700 may be configured to generate scalable content including a base bitstream and multiple additional enhancements that may provide improved visual quality as described below. In order to perform its functions, the functions of the scalable encoder 700 may be incorporated into and performed by the adaptive preprocessor 240 and the ROI encoder 250 of FIG. 2. For example, the image-based salience detector 310, the depth-based salience corrector 320, and the preprocessors 730 may be functions performed by the adaptive preprocessor 240 and the encoders 740 may be functions performed by the ROI encoder 250.

The scalable encoder 700 may be configured to receive source content 104 and depth information. The scalable encoder 700 may comprise the image-based salience detector 310 of FIG. 3 and the depth-based salience corrector 320 of FIG. 3. The image-based salience detector 310 and the depth-based salience corrector 320 may be configured as described above with reference to FIG. 3. As described below, the scalable encoder 700 may be configured to preprocess and encode the source content 104 into two or more layers depending on the depth-based salience information for the source content 104.

The scalable encoder 700 may comprise a base layer preprocessor 730a coupled to the depth-based salience corrector 320 of FIG. 7. The base layer preprocessor 730a may be configured to receive the source content 104 and the depth-based salience information from the salience corrector 320. The base layer preprocessor 730a may be configured to preprocess (e.g., low-pass filter) the source content 104 in order to achieve a minimum level of fidelity (e.g., similarity between the source content 104 and the encoded content), where fidelity may be measured using a combination of SNR (Signal-to-Noise Ratio), spatial, and temporal resolution. As such, the base layer preprocessor 730a may be configured to provide base layer content that may be encoded at a smaller bit rate.

The scalable encoder 700 may also comprise a base layer encoder 740a coupled to the base layer preprocessor 730a. The base layer encoder 740a may be configured to receive and encode the preprocessed base layer content from the base layer preprocessor 730a. The encoded base layer content may comprise base layer pictures, or other information such as base layer motion vectors and base layer encoding modes. The base layer encoder 740a may be configured to generate a base bitstream comprising the encoded base layer content.

The scalable encoder 700 may also comprise a layer 1 preprocessor 730b coupled to the depth-based salience corrector 320. The layer 1 preprocessor 730b may be configured to receive the source content 104 and the depth-based salience information from the depth-based salience corrector 320. The layer 1 preprocessor 730b may be configured to preprocess the source content 104 such that more salient objects in the source content 104 are given a higher fidelity and less salient objects are given a lower fidelity. The layer 1 preprocessor 730b may be configured to provide preprocessed layer 1 content.

The scalable encoder 700 may also comprise a layer 1 encoder 740b coupled to the layer 1 preprocessor 730b and the base layer encoder 740a. The layer 1 encoder 740b may be configured to receive the preprocessed layer 1 content from the layer 1 preprocessor 730b and the encoded base layer content from the base layer encoder 740a. The layer 1 encoder 740b may be configured to encode the layer 1 preprocessed content using the decoded base layer content as a reference. In exemplary embodiments, the layer 1 encoder 740b may be configured to encode residual (e.g., difference) information that may provide additional bits indicating differences between the higher fidelity layer 1 content and the base layer content. The layer 1 encoder 740b may be configured to generate an enhancement 1 bitstream comprising the encoded layer 1 residual information.

The scalable encoder 700 may also comprise a layer 2 preprocessor 730c coupled to the depth-based salience corrector 320. In one embodiment, the layer 2 preprocessor 730c may be configured to act as a pass-through for the source content 104 such that the source content 104 is unchanged. In another embodiment, the layer 2 preprocessor 730c may be configured to generate an additional enhancement bitstream comprising another depth-based layer of residual information. In this embodiment, the layer 2 preprocessor 730c may be configured to define a depth layer based on the depth-based salience information from the depth-based salience corrector 320 and may process (e.g., low-pass filter) the source content 104 to achieve a determined level of fidelity. The layer 2 preprocessor 730c may be configured to provide preprocessed layer 2 content.

The scalable encoder 700 may also comprise a layer 2 encoder 740c coupled to the layer 2 preprocessor 730c and the layer 2 encoder 740c. The layer 2 encoder 740c may be configured to receive the preprocessed layer 2 content from the layer 2 preprocessor 730c and the encoded layer 1 content from the layer 1 encoder 740b. The layer 2 encoder 740c may encode residual information indicating the differences between the preprocessed layer 1 content and the preprocessed layer 2 content as described above. The layer 2 encoder 740c may be configured to generate enhancement bitstream 2 comprising the residual information as additional bits.

In other embodiments, the scalable encoder 700 may comprise n preprocessors 730 and n encoders 740, where n is an integer. As described above, each layer n preprocessor 730 may be configured to receive the source content 104 and may be coupled to the depth-based salience corrector 320. As described above, each layer n encoder 740 may be coupled to the layer n preprocessor 730 and may be configured to receive the preprocessed layer n content and the encoded layer n−1 content from the layer n−1 encoder 740. Each layer n encoder 740 may be configured to generate an enhancement n bitstream as described above.

The scalable encoder 700 may be further configured to combine the base bitstream, the enhancement 1 bitstream, and the enhancement 2 bitstream in order to provide a scalable bitstream that may be transmitted to a scalable or non-scalable receiver (e.g., client 130). In embodiments where the depth-adaptive streaming encoding system 110 comprises the scalable encoder 700, the communication transmitter 260 may be configured to transmit only the base bitstream, or the base bitstream and one or more enhancement layers depending on the available bandwidth of the distribution network 120.

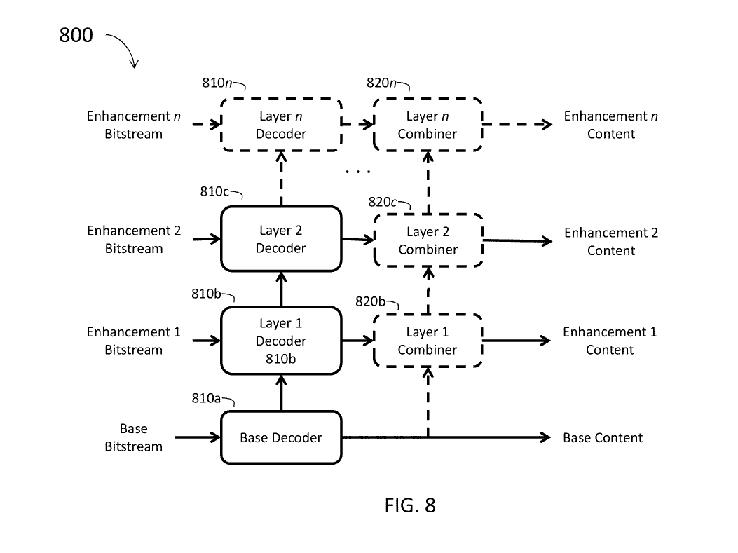

FIG. 8 is a functional block diagram of a receiver 800 that may receive the scalable encoded bitstream generated by the scalable video encoder 700 of FIG. 7, in accordance with exemplary embodiments of the invention. In some embodiments, the receiver 800 may be a component of the client 130 of FIG. 1 and the client 130 may be configured to receive and decode the scalable encoded bitstream. In exemplary embodiments, the scalable encoded bitstream may comprise the base bitstream, the enhancement 1 bitstream, and the enhancement 2 that may comprise base layer content and residual information as described above with reference to FIG. 7. The receiver 800 may be configured to parse the scalable encoded bitstream into the individual bitstreams comprised therein.

The receiver 800 may comprise a plurality of decoders 810. Each decoder 810 may be configured to receive one of the received bitstreams. In an exemplary embodiment, the receiver 800 may comprise a base decoder 810a configured to receive and decode the base bitstream into the base content.

The receiver 800 may also comprise a layer 1 decoder 810b coupled to the base decoder 810a and configured to receive the enhancement 1 bitstream and decoded base content from the base decoder 810a. The layer 1 decoder 810b may be configured to decode the enhancement 1 bitstream into layer 1 residual information. In some embodiments, the layer 1 decoder 810b may receive input from the base decoder 810a, such as reference images, predicted motion vectors, and predicted encoding modes.

The receiver 800 may also comprise a layer 1 combiner 820b coupled to the layer 1 decoder 810b and the base decoder 810a. The layer 1 combiner 820b may be configured to receive the base content from the base decoder 810a and the layer 1 residual information from the layer 1 decoder 810b. The layer 1 combiner 820b may be configured to combine the layer 1 residual information with the base content to generate enhancement 1 content. The enhancement 1 content may provide higher fidelity to more salient objects in the base content as described above.

The receiver 800 may also comprise a layer 2 decoder 810c coupled to the layer 1 decoder 810b and configured to receive the enhancement 2 bitstream and the layer 1 residual information from the layer 1 decoder 810b. The layer 2 decoder 810c may be configured to decode the enhancement 2 bitstream into layer 2 residual information as described above.

The receiver 800 may also comprise a layer 2 combiner 820c coupled to the layer 2 decoder 810c and the layer 1 combiner 820b. The layer 2 combiner 820c may be configured to receive the layer 2 residual information from the layer 2 decoder 810c and the enhancement 1 content from the layer 1 combiner 820b. The layer 2 combiner 820c may be configured to combine the layer 2 residual information with the enhancement 1 content to generate enhancement 2 content. The enhancement 2 content may provide higher fidelity compared to the enhancement 1 content as described above.

In some embodiments, the receiver 800 may only be capable of handling the base content. In this embodiment, the receiver 800 may only decode the base bitstream. In other embodiments, the receiver 800 may be capable of handling the enhancement layers to scale the base content as described above. In other embodiments, the receiver 800 may receive n bitstreams and the receiver 800 may comprise n decoders 810 and n−1 combiners 820, where n is an integer. As described above, each decoder 810 may be configured receive and decode one of the bitstreams to provide either base content or residual information. As described above, each combiner 820 may be coupled to the corresponding decoder 810 and may be configured to receive residual information from associated decoder 810. Each combiner 820 may also be configured to receive base content or enhancement content from the n−1 combiner 820 and may be configure to combine that content with the residual information received from the associated decoder 810 to provide enhancement n content.

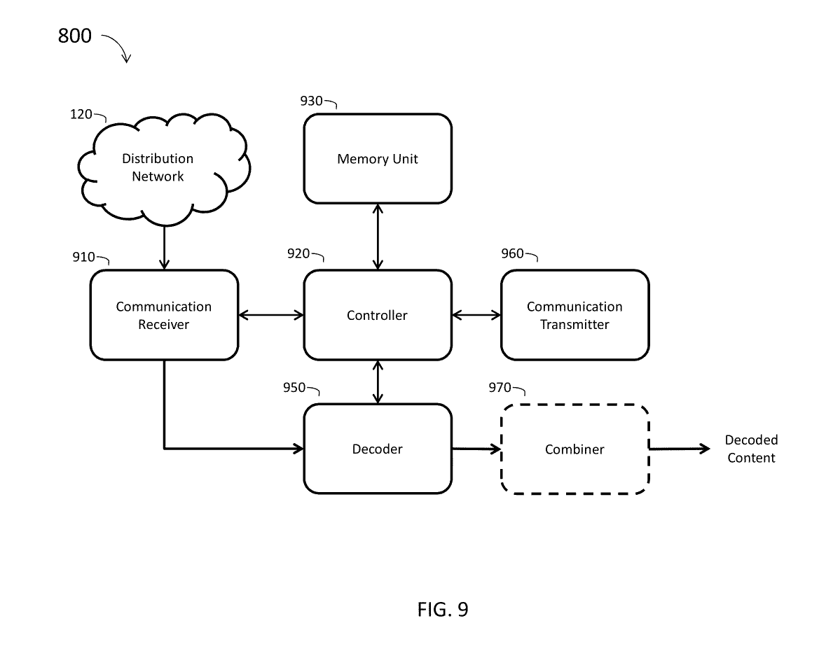

FIG. 9 is a functional block diagram of the receiver 800 of FIG. 8, in accordance with exemplary embodiments of the invention. As described above, the receiver 800 may be incorporated into a client 130 and the receiver 800 may be configured to receive and decode encoded content such that the content may be displayed on a display of the client 130.

The receiver 800 may comprise a communication receiver 910. The communication receiver 910 may be configured similar to the communication receiver 210 of FIG. 2. The communication receiver 910 may be further configured to receive bit streams comprising encoded content from the communication transmitter 260 of the encoding system 110 via the distribution network 120. The bitstreams may comprise encoded image or video content as described above. In some embodiments, as discussed above with reference to FIG. 8, the communication receiver 910 may be configured to receive scalable encoded bitstreams generated by the scalable encoder 700 of FIG. 7.

The receiver 800 may also comprise a controller 920 coupled to the communication receiver 910. The controller 920 may be configured similar to the controller 220 of FIG. 2. The controller 920 may comprise a micro-controller or a processor. Similar to the controller 220 of FIG. 2, the controller 920 may be configured or programmed with instructions to receive information from each of the components of the receiver 800, perform calculations based on the received information, and generate control signals for each of the components of the receiver 800 based on the performed calculations in order to adjust an operation of each component. The controller 920 may be further configured to detect channel characteristics (e.g., bandwidth, latency, and SNR) of the distribution network 120. The controller 920 may also be configured to generate encoding parameters based on the detected channel characteristics and the characteristics of the display device of the client 130.

The receiver 800 may also comprise a memory unit 930 coupled to the controller 920. The memory unit 930 may be configured similar to the memory unit 230 as of FIG. 2.

The receiver 800 may also comprise a communication transmitter 960 coupled to the controller 920. The communication transmitter 960 may be configured similar to the communication transmitter 260 of FIG. 2. The communication transmitter 960 may be configured to receive the encoding parameters from the controller 920 and may be configured to transmit the encoding parameters to the communication receiver 210 of the encoding system 110 of FIG. 2.

The receiver 800 may also comprise a decoder 950 coupled to the controller 920 and the communication receiver 910. The decoder 950 may be configured to receive the encoded content from the communication receiver 910. The decoder 950 may be configured according to the same coding standard as the encoder 250 of the encoding system 110 of FIG. 2. As such, the decoder 950 may be configured to decode the received encoded content generated by the encoding system 110 of FIG. 2 and provide decoded content. The decoded content may be provided to the display of the client 130.

In some embodiments where the encoded content comprises a base bitstream and multiple enhancement bitstreams as described above with reference to FIG. 8, the receiver 800 may comprise a combiner 970 coupled to the decoder 950. The combiner 970 may be configured to receive and combine the decoded base layer and enhancement layers from the decoder 950 as described above with reference to FIG. 8. The combiner may be configured to provide the combined content as decoded content that may be provided to the display of the client 130.

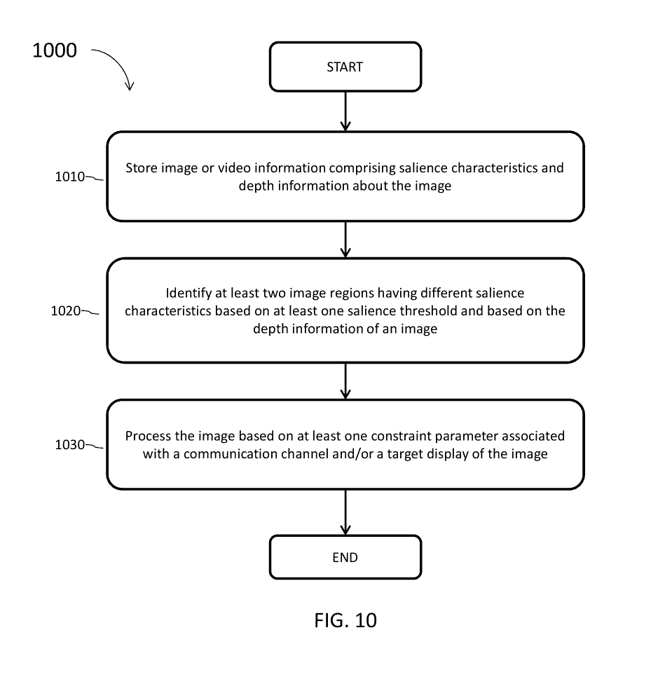

FIG. 10 is a flowchart of a method 1000 for depth-based adaptive streaming of source content, in accordance with exemplary embodiments of the invention. At block 1010, the method may store image or video information comprising salience characteristics and depth information about the image. At block 1020, the method may identify at least two image regions having different salience characteristics based on at least one salience threshold and based on the depth information of an image. At block 1030, the method may process the image based on at least one constraint parameter associated with a communication channel and/or a target display of the image. The image processing performed by the method of FIG. 10 may be equivalent to the image processing of the depth-based adaptive streaming encoding system 110 of FIG. 2 as described above.

Information and signals disclosed herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may be implemented in hardware, software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Various embodiments of the invention have been described. These and other embodiments are within the scope of the following claims.

What is claimed is:

1. An apparatus for processing image or video information, the apparatus comprising:
a memory unit configured to store image or video information comprising salience characteristics and depth information of the image or video information; and
a processor operationally coupled to the memory and configured to identify at least two image regions having different salience characteristics based on at least one salience threshold and based on the depth information of the image or video information, and further configured to process the image based on at least one constraint parameter associated with a communication channel and/or a target display of the image.

2. The apparatus of claim 1, wherein the processor is further configured to determine a most salient image region of the image or video information and identify the at least two image regions based on a distance from the most salient image region.

3. The apparatus of claim 1, wherein the processor is further configured to identify the at least two image regions based on the equation S_{ID}(x)=S_{I}(x)*exp(−k*abs(D₀−d(x))), where S_{ID}(x) is a depth-based salience value for a pixel at location x in the image or video information, S_{I}(x) is an image-based salience value for the pixel at location x based on the salience characteristics, k is a constant that determines a depth-based correction strength, D₀ is a constant representing a most salient image region of the at least two image regions based on the on the salience characteristics and the depth information, and d(x) is a depth value for the pixel at location x.

4. The apparatus of claim 3, wherein the processor is further configured to identify a first image region of the at least two image regions to comprise one or more pixels having Sid(x) that falls below the at least one salience threshold and identify a second image region of the at least two image regions to comprise one or more pixels having Sid(x) that falls above the at least one salience threshold

5. The apparatus of claim 1, wherein the at least two image regions comprise a first depth layer and a second depth layer, the first depth layer being more salient than the second depth layer.

6. The apparatus of claim 5, wherein the processor is further configured to process the first depth layer at a quantization parameter setting of a quality that is higher than a quantization parameter setting for the second depth layer.

7. The apparatus of claim 5, wherein the processor is further configured to process the first depth layer using a first macroblock coding mode of a quality that is higher than a macroblock coding mode for the second depth layer.

8. The apparatus of claim 5, wherein the processor comprises a low-pass filter circuit and is configured to low-pass filter the second depth layer.

9. The apparatus of claim 1, wherein the processor is further configured to scale a resolution of the image to improve perceived video information to accommodate the communication channel and/or target display of the image.

10. The apparatus of claim 1, wherein the processor comprises a controller circuit, a preprocessor circuit, and an encoder circuit.

11. The apparatus of claim 1, further comprising a rendering engine configured to generate the image or video information and the depth information.

12. The apparatus of claim 1, wherein the constraint parameter comprises at least one of a target bit rate, a maximum instantaneous bit rate, a minimum instantaneous bit rate, and a length of a group of pictures, and a display resolution.

13. The apparatus of claim 1, wherein the image is processed at a first fidelity level and the processor is further configured to process the image at a second fidelity level to generate residual information, the second fidelity level higher than the first fidelity level.

14. The apparatus of claim 1, wherein the processor is further configured to partition the image into a plurality of depth-salience layers based on the at least one salience threshold.

15. The apparatus of claim 14, wherein the processor is further configured to employ a masking process to at least one of the plurality of layers to remove pixel information not belonging, and pass through pixel information belonging, to the one of the plurality of layers.

16. The apparatus of claim 15, wherein the processor is further configured to add the plurality of layers together and perform blending operations to blend boundaries between the plurality of layers.

17. The apparatus of claim 1, further comprising an adjustment circuit configured to adjust a quantization parameter based on the salience characteristics and depth information.

18. The apparatus of claim 17, wherein the processor is configured to use the depth information as input to determine a depth-based salience value for each pixel of the image.

19. The apparatus of claim 18, wherein the processor is configured to use the depth-based salience value or a derivation thereof to determine an adjustment value for the quantization parameter that determines an adjusted quantization parameter.

20. The apparatus of claim 19, wherein the processor is configured to normalize the adjusted quantization parameter to determine a target average adjusted quantization parameter based at least in part on a target bit rate of the communication channel.

21. A method for processing image or video information, the method comprising:
storing image or video information comprising salience characteristics and depth information of the image or video information;
identifying at least two image regions having different salience characteristics based on at least one salience threshold and based on the depth information of the image or video information; and
processing the image based on at least one constraint parameter associated with a communication channel and/or a target display of the image.

22. The method of claim 21, further comprising processing a foreground block of the image at a quantization parameter setting of a quality that is higher than a quantization parameter setting for a background block of the image.

23. The method of claim 21, further comprising scaling a resolution of the image to improve perceived video information to accommodate the communication channel and/or target display of the image.

24. The method of claim 21, further comprising:
partitioning the image into a plurality of depth-salience layers based on the at least one salience threshold; and
employing a filter to one the plurality of layers to filter out pixel information not belonging, and passing through pixel information belonging, to the one of the plurality of layers.

25. The method of claim 21, further comprising:
adjusting a quantization parameter based on the salience characteristics and depth information;
determining a depth-based salience value for each pixel of the image based on the depth information;
determining an adjustment value for the quantization parameter that determines an adjusted quantization parameter based on the depth-based salience value or a derivation thereof; and
normalizing the adjusted quantization parameter to determine a target average adjusted quantization parameter based at least in part on a target bit rate of the communication channel.

26. An apparatus for processing image or video information, the apparatus comprising:
means for identifying at least two image regions having different salience characteristics based on at least one salience threshold and based on the depth information of the image or video information; and
means for processing the image based on at least one constraint parameter associated with a communication channel and/or a target display of the image.

27. The apparatus of claim 26, wherein the identifying means comprises a controller circuit and the processing means comprises a preprocessing circuit.

28. The apparatus of claim 26, further comprising:
means for partitioning the image into a plurality of depth-salience layers based on the at least one salience threshold; and
means for filtering one the plurality of layers to filter out pixel information not belonging, and passing through pixel information belonging, to the one of the plurality of layers.

29. The apparatus of claim 26, wherein the partitioning means comprises a masking circuit and the filtering means comprises a low-pass filter circuit.
